(19) United States
(12) Patent Application Publication
(10) Pub. No.: US 2026/0227279 A1
(43) Pub. Date: Aug. 6, 2026

(54) AUTOMATED INSPECTION AND CLEANING OF OPTICAL FIBER COMPONENTS

(71) Applicant: Microsoft Technology Licensing, LLC, Redmond, WA (US)

(72) Inventors: Antony Ian Taylor ROWSTRON, Cambridge (GB); Tae Woo HONG, London (GB); Hugh David Paul WILLIAMS, Cambridge (GB); David Anthony SWEENEY, Cratloe (IE); Andromachi CHATZIELEFTHERIOU, Cambridge (GB); Elliott Louis HOGG, Manningtree (GB)

(73) Assignee: Microsoft Technology Licensing, LLC, Redmond, WA (US)

(21) Appl. No.: 19/043,112

(22) Filed: Jan. 31, 2025

(51) Int. Cl. G01M 11/00; G01M 11/02; G02B 6/38

(52) U.S. Cl. CPC G01M 11/30; G01M 11/0214; G02B 6/3866

(57) ABSTRACT

Robotic systems and methods for operating a robotic system to perform inspection and cleaning of optical fiber components are disclosed. A robotic system for performing automated inspection and cleaning of optical fiber components comprises a transceiver receptacle moveably secured to a chassis and configured to removably retain an optical fiber transceiver. A clamp moveably secured to the chassis is configured to remove an optical fiber connector from the transceiver and reinsert the optical fiber connector into the transceiver. An inspection tool is non-moveably affixed to the chassis and configured to inspect one or more fiber ends of the transceiver and one or more fiber ends of the optical fiber connector. A cleaning tool is non-moveably affixed to the chassis and configured to clean the fiber end(s) of the optical fiber connector and the fiber end(s) of the optical fiber transceiver.

### BACKGROUND

Optical fiber connectors and transceivers are available in many different configurations and form factors. Inspection and cleaning of optical surfaces in these components can improve data transmission efficiencies and reduce downtime.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed and further described below that relate to automated inspection and cleaning of optical fiber components. In one example and as described below, a robotic system for automated inspection and cleaning of optical fiber components comprises a transceiver receptacle moveably secured to a chassis of the robotic system and configured to removably retain an optical fiber transceiver. A clamp is moveably secured to the chassis and configured to remove an optical fiber connector from the optical fiber transceiver and reinsert the optical fiber connector into the optical fiber transceiver. An inspection tool is non-moveably affixed to the chassis and configured to inspect one or more fiber ends of the optical fiber transceiver and one or more fiber ends of the optical fiber connector. A cleaning tool is non-moveably affixed to the chassis and configured to clean the fiber end(s) of the optical fiber connector and the fiber end(s) of the optical fiber transceiver.

### BRIEF DESCRIPTION OF THE DRAWINGS

FIG. 1 shows a rear view of one example of a robotic system for automated inspection and cleaning of optical fiber components, along with an optical fiber connector seated in an optical fiber transceiver, according to the present disclosure.

FIG. 2 shows a front view of the robotic system of FIG. 1 with the optical fiber transceiver seated in a transceiver receptacle.

FIG. 3 shows a clamp of the robotic system translating to the optical fiber connector and transceiver.

FIG. 4 shows the clamp engaging the optical fiber connector.

FIG. 5 shows the clamp moved in the positive Y-axis direction to remove the optical fiber connector from the optical fiber transceiver.

FIG. 6 shows the clamp and optical fiber connector translated in the positive X-axis direction to align a fiber end of the optical fiber connector with an inspection tool.

FIG. 7 shows one fiber end of the optical fiber connector aligned with the inspection tool.

FIG. 8 shows the clamp and optical fiber connector translated in the positive X-axis direction to align and contact a fiber end of the optical fiber connector with a cleaning tool.

FIG. 9 shows the fiber ends of the optical fiber connector aligned with a cleaning tool.

FIG. 10 shows the optical fiber transceiver and transceiver receptacle being translated and rotated from a loading orientation toward a servicing orientation.

FIG. 11 shows a partial view from FIG. 10 of a spur gear affixed to the transceiver receptacle engaging a pinion to rotate the transceiver receptacle and transceiver.

FIG. 12 shows the transceiver receptacle and transceiver in the servicing orientation.

FIG. 13 shows the transceiver receptacle and transceiver translated in the positive X-axis direction to align a fiber end of the transceiver with the inspection tool.

FIG. 14 shows one fiber end of the optical fiber transceiver aligned with the inspection tool.

FIG. 15 shows the transceiver receptacle and transceiver translated in the positive X-axis direction to align and contact a fiber end of the transceiver with a cleaning tool.

FIGS. 16A-16B are a flow chart of a method for operating a robotic system to perform inspection and cleaning of an optical fiber connector and an optical fiber transceiver according to examples of the present disclosure.

FIG. 17 shows a block diagram of an example computing system according to examples of the present disclosure.

### DETAILED DESCRIPTION

Inspection and cleaning of optical surfaces in optical fiber components during manufacturing and in the field can improve data transmission efficiencies and reduce downtime. For example, inspection tools in the form of hand-held microscopes can be utilized to manually inspect optical surfaces on the end-face of optical fiber connectors and on the mating face of a transceiver for contaminants or blemishes. Hand-held and manually operated optical fiber cleaning tools can be used to clean these optical surfaces.

Many existing optical fiber inspection and cleaning tools are manually operated and require separate adapters with mechanical alignment features between the inspection tool and the different configurations of optical fiber connectors and transceivers. Positioning these manually operated tools requires contact between the tool and the optical fiber connector or transceiver. Further, when cleaning an optical fiber connector or transceiver, a technician will often pick up different tools and move about, which increases the chances of introducing contaminants into the optical fiber component. Accordingly, current manual inspection and cleaning processes can be time-consuming and create opportunities for inadvertent damage and introduction of contaminants into the components.

For example, the process of selecting and manually installing the proper adapter on an inspection tool, handling an optical fiber transceiver, removing an optical fiber connector from the transceiver, and aligning an inspection tool with an optical surface of the optical fiber connector to capture inspection images of the surface can be quite time-consuming. Additionally, in examples of optical fiber connectors and transceivers that accommodate multiple optical fibers, during inspection a technician is required to individually inspect each optical surface by separately positioning, aligning, and imaging each optical surface with the inspection tool. The manual handling of the tool, adapter, transceiver, and optical fiber connector along with the physical contact between the tool and the optical fiber connector and transceiver also can result in damage and/or the introduction of dust or other contaminants. Further, because of the wide variety of optical fiber connectors and transceivers having many different configurations and form factors, a unique and separate adapter is required for inspecting and cleaning each different configuration of connector and transceiver.

Accordingly and as described in more detail below, the present disclosure describes robotic systems and corresponding methods that perform automated inspection and cleaning of a variety of different optical fiber components, including automated disassembly and reassembly of optical fiber connectors and corresponding transceivers. Advantageously, utilizing the systems of the present disclosure to perform inspection and cleaning greatly increases the speed and quality of such processes and reduces the likelihood of introducing external contaminants into the components, thereby avoiding the disadvantages and risks described above. Additionally, in different use cases and as described further below, systems of the present disclosure can receive a transceiver with inserted optical fiber connector as an assembled unit, remove the optical fiber connector from the transceiver for inspection and cleaning, and then insert the cleaned optical fiber connector into the transceiver. In some examples, while the optical fiber connector is removed from the transceiver, the transceiver is inspected and cleaned. In other examples, a transceiver without an optical fiber connector can be manually inserted into a transceiver receptacle for inspection and cleaning.

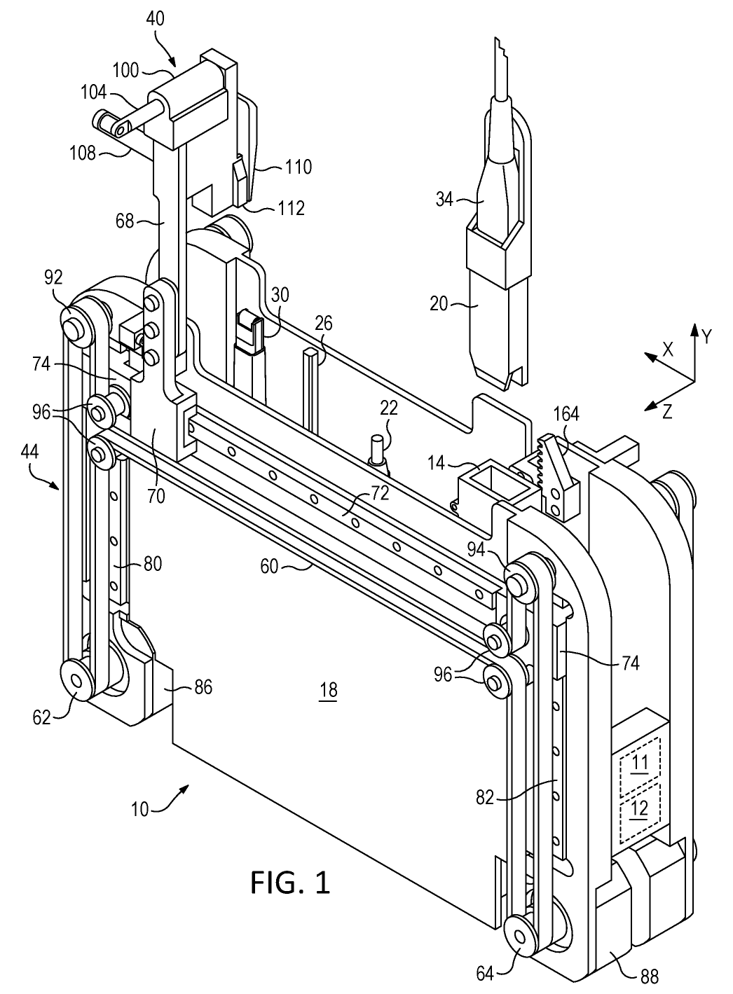

FIGS. 1-15 and 17 show one example of a robotic system 10 for performing automated inspection and cleaning of optical fiber components. As described in more detail below and in different use cases, system 10 is configured to inspect a fiber end of an optical fiber component by moving the optical fiber component to a fixed inspection tool. The optical fiber component is then moved to contact a fixed cleaning tool to clean the fiber end of the component. In some examples, operation of system 10 can be managed and controlled by software services running in a cloud environment, such as via a services API. As described further below, in this example system 10 includes at least one processor 11 and memory 12 storing instructions executable by the processor to control the motors, mechanisms, and other components of the system to perform automated inspection and cleaning of optical fiber components.

In some examples robotic system 10 comprises an enclosure (not shown) that contains the components described herein. In different embodiments the system 10 and enclosure can be worn or held by a human user, such as worn as a body-mounted unit, mounted on a fixed structure such as a table, mounted to a separate robotic system, or utilized in other manners. In some examples the enclosure can include a display and/or other output or user input features.

In the present example and as described in more detail below, the system 10 is configured to perform inspection and cleaning services for optical fiber connectors and transceivers having a plurality of configurations and in a variety of different use cases. The present examples are described with respect to optical fiber transceivers in the forms of quad small form-factor pluggable (QSFP) transceivers having either Multi-fiber Push On (MPO) or Lucent Connector (LC) configurations, and corresponding optical fiber connectors having either MPO or LC configurations. It will be appreciated that the principles of the present disclosure can be utilized with a variety of other configurations of optical fiber connectors and transceivers having different form factors, capabilities, components, and/or other features.

In the present example and as described further below, robotic system 10 includes a transceiver receptacle 14 moveably secured to a chassis 18 of the robotic system and configured to removably retain an optical fiber transceiver 20. Robotic system 10 includes an inspection tool 22 non-movably affixed to chassis 18 and configured to inspect a fiber end of an optical fiber connector and a fiber end of an optical fiber transceiver. System 10 further includes a first cleaning tool 26 that is non-moveably affixed to chassis 18 and configured to clean the fiber end of a first configuration of optical fiber connector, such as an LC connector. First cleaning tool 26 is also configured to clean the fiber ends of a corresponding first configuration of optical fiber transceiver, such as an LC transceiver.

In the present example, system 10 also comprises a second configuration of cleaning tool 30 non-moveably affixed to the chassis 18 and configured to clean a fiber end of at least a second configuration of optical fiber connector, such as an MPO connector, and second configuration of an optical fiber transceiver, such as an MPO transceiver. Additionally, as described further below and in another potential advantage of the present disclosure, second cleaning tool 30 is configured to also clean the fiber end of the first configuration of optical fiber connector, such as an LC optical fiber connector, thereby potentially providing an improved cleaning performance as compared to the first configuration of cleaning tool.

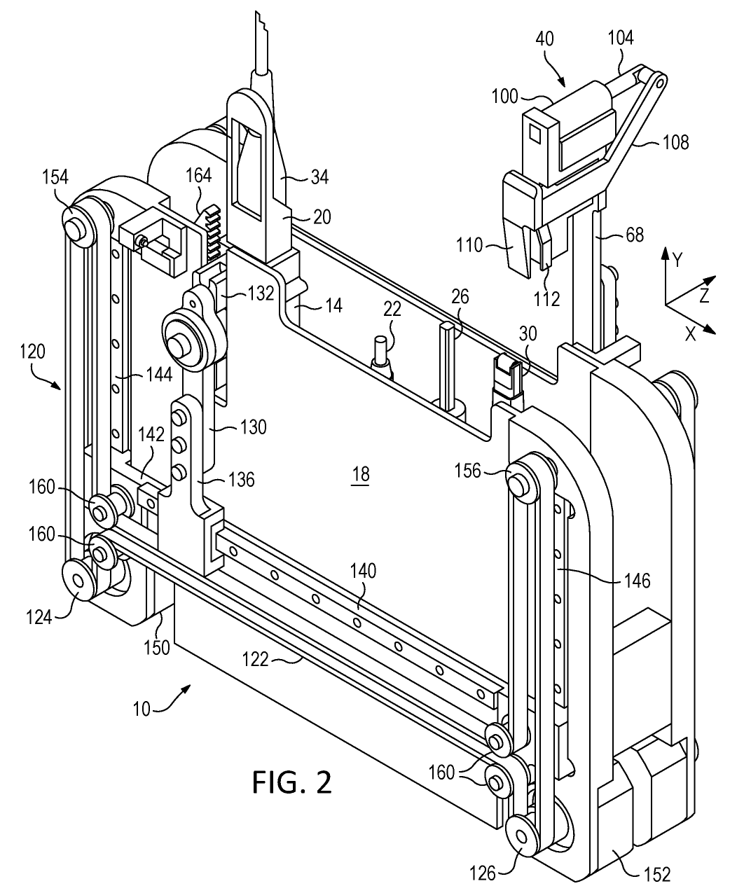

FIGS. 1 and 2 illustrate system 10 and an LC optical fiber connector 34 inserted in a corresponding LC optical fiber transceiver 20. In these figures, transceiver receptacle 14 is shown in a loading orientation at which the optical fiber transceiver 20 (and in some examples seated LC optical fiber connector 34) can be inserted and removably retained in the receptacle as shown in FIG. 2. In some examples, transceiver receptacle 14 is also configured to removably retain another configuration of optical fiber transceiver that accepts MPO optical fiber connectors.

As described further below, and in another potential advantage of the present disclosure, system 10 includes a moveable clamp, multiple positioning mechanisms, and other components that provide automated handling, inspection, and cleaning of optical fiber connectors and transceivers. With reference to FIGS. 1 and 2, system 10 includes a moveable clamp 40 configured to remove optical fiber connector 34 from the optical fiber transceiver 20 retained in the transceiver receptacle 14, translate the optical fiber connector to the inspection tool 22 for inspection and to either the first cleaning tool 26 or second cleaning tool 30 for cleaning, and reinsert the connector into the transceiver.

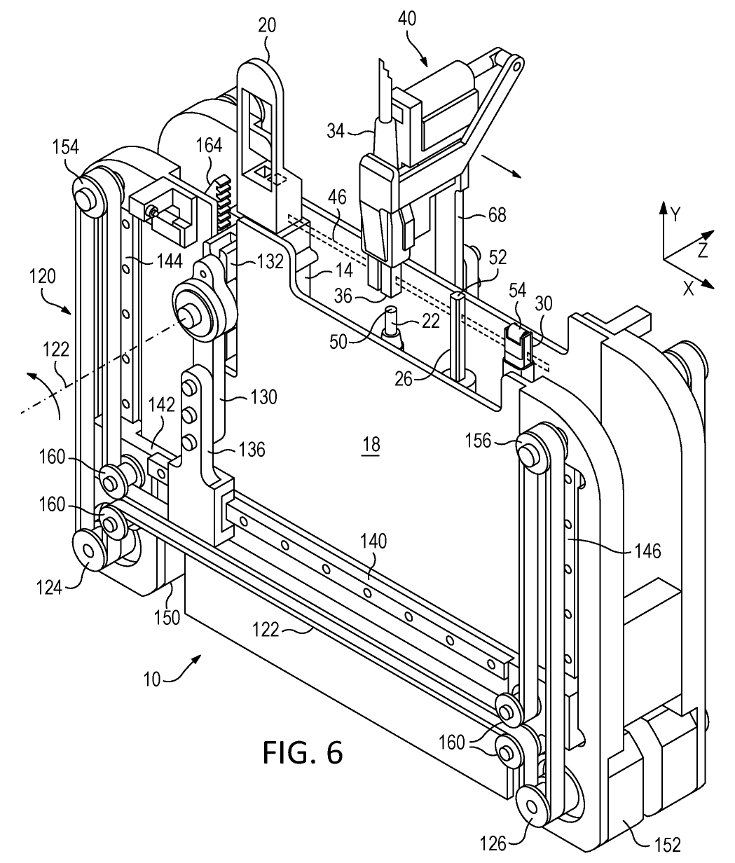

With reference to FIG. 1, to translate the optical fiber connector 34 for inspection, cleaning, and reinsertion into the transceiver 20, clamp 40 is mounted to a clamp positioning mechanism 44 that moves the clamp with two degrees of freedom along the X-axis and Y-axis. As described further below, the clamp positioning mechanism 44 restricts the clamp to movement in a first direction and a second direction orthogonal to the first direction. Additionally and with reference to FIG. 6, the first direction and the second direction define a plane of movement 46 of the clamp 40, and the inspection tool 22, first cleaning tool 26, and second cleaning tool 30 are non-movably affixed in positions coplanar with the plane of movement of the clamp. More particularly and in the present example, the clamp positioning mechanism 44 restricts the movement of clamp 40 and grasped optical fiber connector 34 along plane 46 in the X-axis and Y-axis directions, with a probe tip 50 of the inspection tool 22, a first cleaning tip 52 of the first cleaning tool 26, and a second cleaning tip 54 of the second cleaning tool 30 each located coplanar with the plane 46 of movement of the clamp.

As shown in FIG. 1, in this example clamp positioning mechanism 44 comprises an H-bot mechanism in which a single H-shaped circumferential timing belt 60 connects a first driven pulley 62 and second driven pulley 64. Clamp 40 is mounted to an extension arm 68 that is affixed to and extends from an arm base 70. Arm base 70 is affixed to belt 60 and is slidably coupled to a base rail 72 for translation along the X-axis. Base rail 72 is affixed to a clamp positioning platform 74 that is slidably coupled to a left rail 80 and right rail 82 for translation along the Y-axis.

A first clamp positioning motor 86 drives the first driven pulley 62, and a second clamp positioning motor 88 drives the second driven pulley 64. In this example the timing belt 60 extends around a first idler pulley 92 spaced from the first driven pulley 62 and a second idler pulley 94 spaced from the second driven pulley 64. Timing belt 60 also extends around four idler pulleys 96 rotatably coupled to the clamp positioning platform 74. In this manner and by selectively operating first clamp positioning motor 86 and second clamp positioning motor 88, the clamp 40 can be moved along the X-axis and Y-axis for precise positioning of the optical fiber connector for inspection and cleaning services.

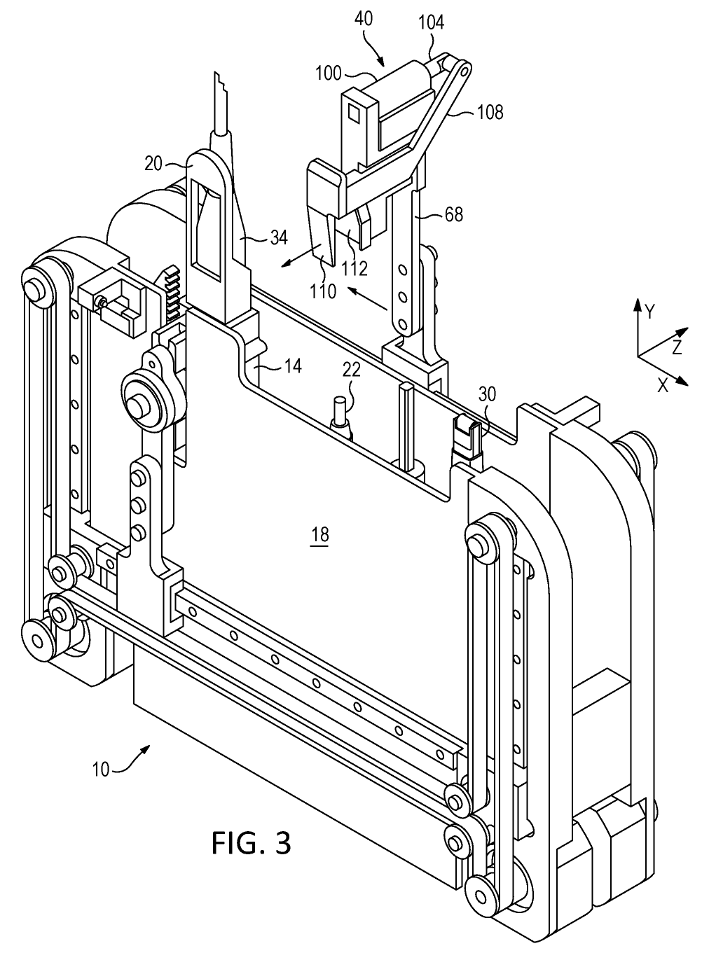

With reference now to FIG. 3-5, clamp positioning mechanism 44 is operated to move clamp 40 along the X-axis and to grasp and remove the optical fiber connector 34 from the transceiver 20. In this example, clamp 40 comprises an actuator 100 that selectively translates a piston 104. A clamp arm 108 slidable in a Z-axis direction joins the piston 104 to a first clamp member 110. In this manner, operation of the piston 104 causes first clamp member 110 to move in the positive and negative Z-axis direction to selectively grasp and release optical fiber connectors against an opposing second clamp member 112.

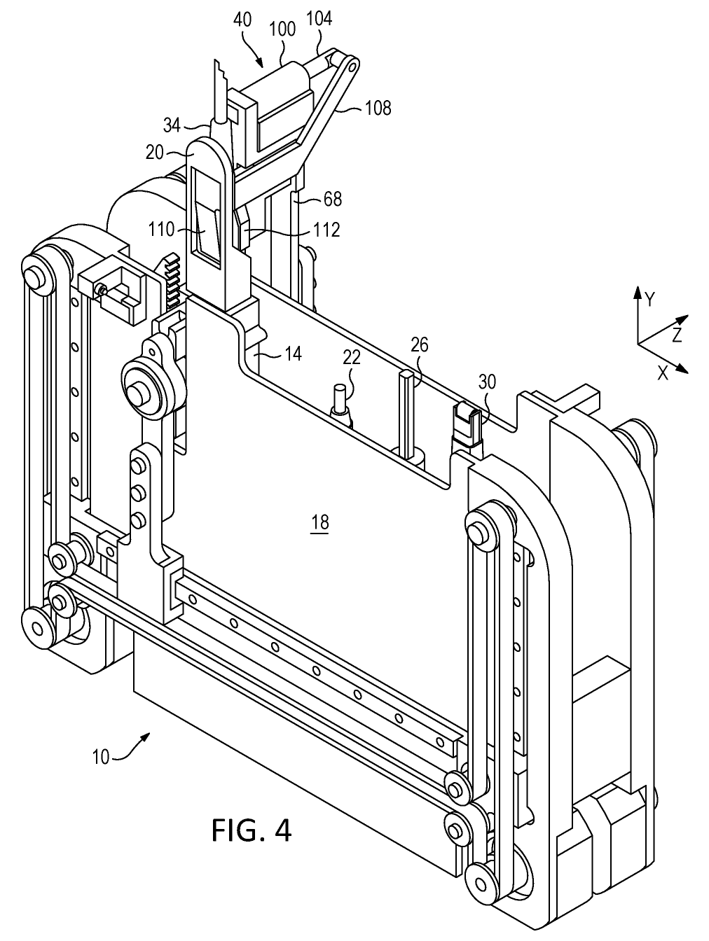

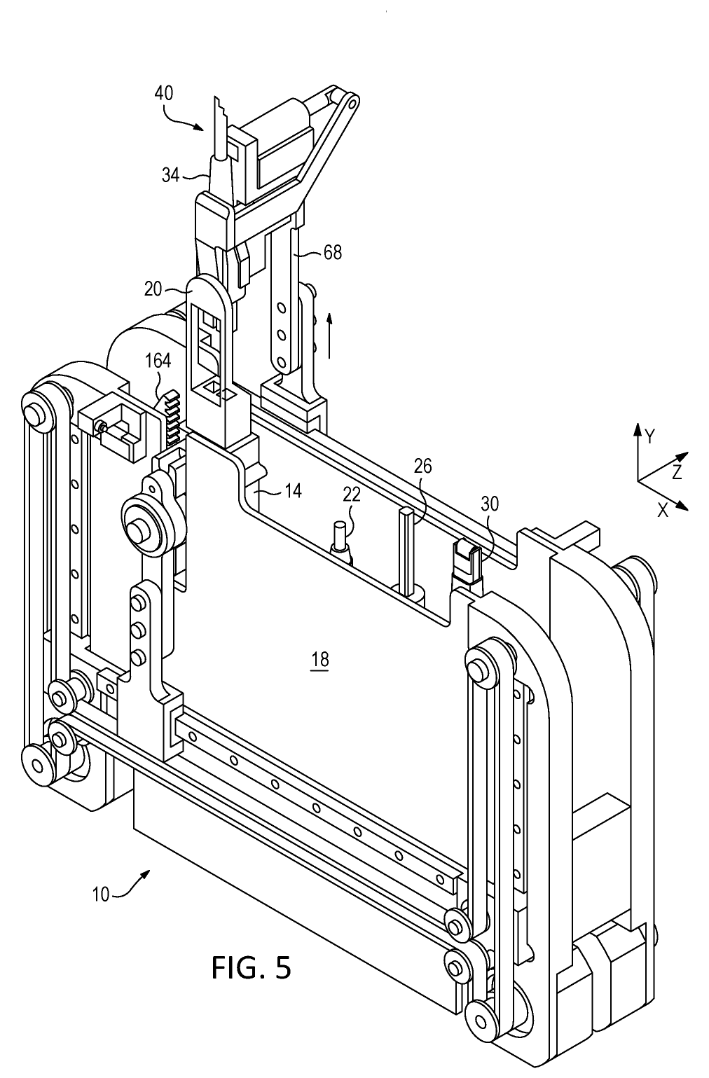

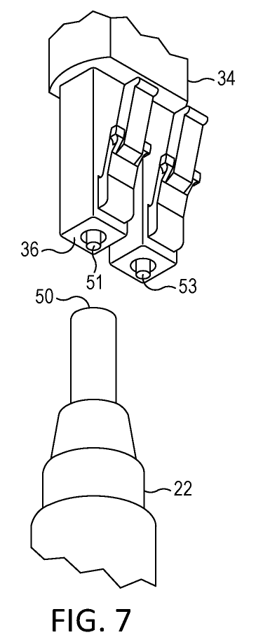

As shown in FIGS. 4 and 5, clamp 40 is moved and operated to grasp and remove the optical fiber connector 34 from the transceiver 20. With reference to FIG. 6, in one example clamp positioning mechanism 44 moves the clamp 40 and optical fiber connector 34 along the X-Y axes and plane 46 to the inspection tool 22 to visually inspect a fiber end 51 (core) on an end face 36 of the optical fiber connector (see FIG. 7). In one potential advantage of the present disclosure, the clamp positioning mechanism 44 is operated to position the fiber end 51 of the optical fiber connector 34 near the probe tip 50 of the inspection tool 22 to inspect the fiber end without contacting another surface. Advantageously, by inspecting the fiber end without contacting another surface, system 10 avoids introducing dust or other contaminants through contact with another surface near the fiber end.

In the present example, optical fiber connector 34 is an LC connector that includes two optical fibers and two corresponding optical fiber ends 51, 53. In this example the clamp positioning mechanism 44 moves the LC connector along the plane 46 in the X-axis direction, stopping at each optical fiber end to inspect the optical fiber end. In some examples, the clamp positioning mechanism 44 adjusts the position of LC connector to capture an accurate image of the fiber end.

In some examples a camera of inspection tool 22 captures one or more images of a fiber end and analyzes the image(s) to detect the core of the fiber end. Once a focused image of the core has been obtained, the image can be partitioned into multiple regions, and each region is processed to detect anomalies that correspond to dirt, dust, or other contaminants or defects. In some examples system 10 runs a classification algorithm to detect the number of anomalies in a specific region of the core, which number is compared to one or more thresholds to determine whether the region passes or fails the inspection. Where all regions pass inspection, cleaning the examined fiber end is not necessary. In other examples, other methods for utilizing an inspection tool to inspect a fiber end for anomalies can be utilized. In another potential advantage, multiple images of a fiber end in the Y-axis direction can be captured, thereby enabling three-dimensional reconstruction of the optical surface to distinguish dirt and dust from micro defects, cracks, etc.

Advantageously and in some examples, when the camera of the inspection tool 22 has been properly positioned in the Y-axis direction to focus on one fiber end 51, the optical fiber connector 34 can be quickly moved laterally in only the X-axis direction to sequentially focus on and inspect the other laterally-aligned fiber end 53 of the connector. Similarly, in examples where the optical fiber connector is an MPO connector that includes 8, 12, or more optical fibers and a corresponding number of optical fiber ends, the MPO connector can be quickly moved laterally in only the X-axis direction to sequentially focus on and inspect the each laterally-aligned fiber end of the connector. In this manner, system 10 enables rapid automated inspection of multiple fiber ends.

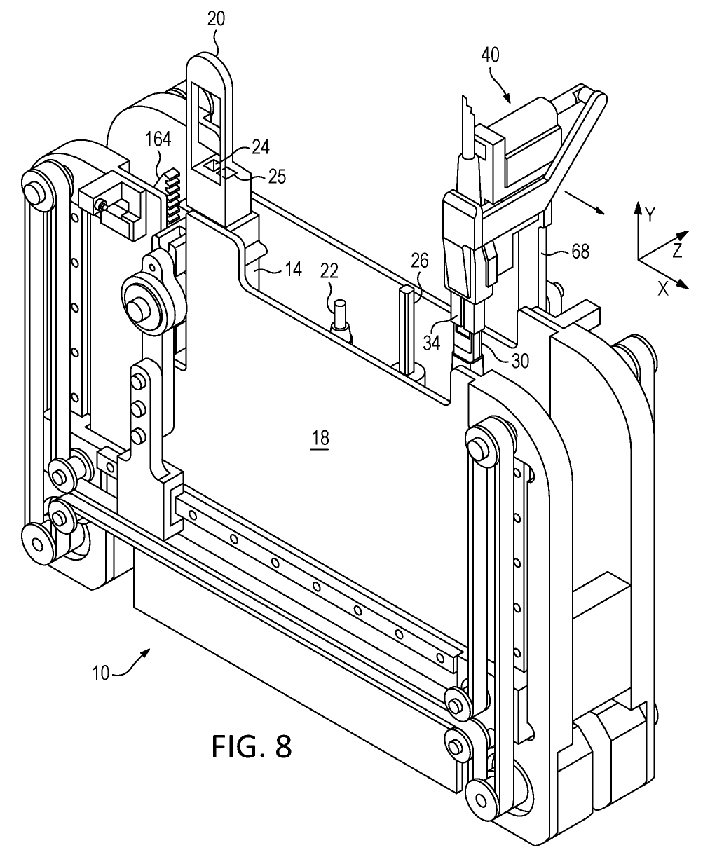

With reference now to FIG. 8, where inspection of a fiber end determines that cleaning of the fiber end is warranted, the clamp positioning mechanism 44 is operated to move the optical fiber connector 34 to either the first cleaning tool 26 (in this example an LC cleaning tool) or the second cleaning tool 30 (in this example an MPO cleaning tool). In another potential advantage of the present disclosure, system 10 can utilize the second cleaning tool 30 to clean the first and second fiber ends 51, 53 of an LC optical fiber connector 34. In this manner, by utilizing the second cleaning tool 30 that includes a wider second cleaning tip 54 that can contact and clean both fiber ends of an LC optical fiber connector simultaneously, system 10 can clean LC optical fiber connectors more efficiently than other methods that use an LC cleaning tool and require separate cleaning operations for each of the two fiber ends.

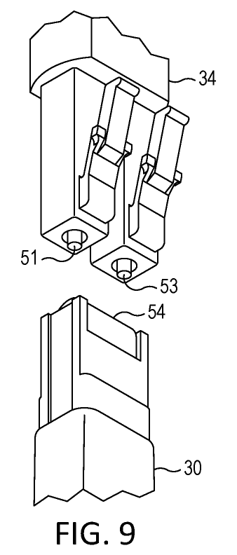

In this example, clamp positioning mechanism 44 is operated to move the optical fiber connector 34 along the X-axis to the second cleaning tool 30 (see FIG. 9), and then move the connector along the Y-axis to cause the two fiber ends 51, 53 to contact the second cleaning tip 54 of the second cleaning tool. In some examples the second cleaning tip 54 comprises a tape or ribbon that is advanced to wipe the fiber ends. In some examples, the fibers ends may be iteratively inspected and cleaned until the fiber ends pass inspection. After inspecting and cleaning (if necessary) optical fiber connector 34, the clamp positioning mechanism 44 is operated to position the optical fiber connector 34 laterally from the second cleaning tool 30 in a parked position.

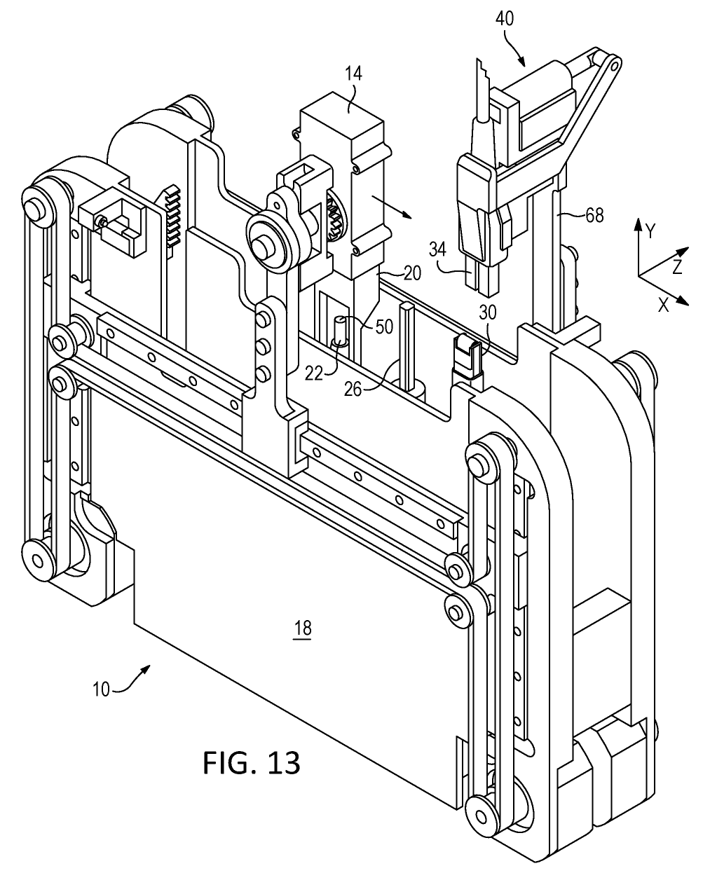

Inspection and cleaning of the optical fiber transceiver 20 will now be described. With reference to FIGS. 6 and 10-12, system 10 includes a transceiver positioning mechanism 120 configured to rotate the transceiver receptacle 14 and translate the transceiver receptacle in a first direction and a second direction orthogonal to the first direction. As described further below, and with reference again to FIG. 6, the first direction and the second direction define a plane of movement 46 of the transceiver receptacle 14, and the transceiver positioning mechanism 120 is configured to rotate the transceiver receptacle about a rotation axis 122 perpendicular to the plane of movement from the loading orientation shown in FIG. 6 to a servicing orientation shown in FIG. 12.

To translate the transceiver receptacle 14 for inspection and cleaning, transceiver positioning mechanism 120 comprises an H-bot mechanism, similar to the clamp positioning mechanism 44, that moves the transceiver receptacle 14 with two degrees of freedom along the X-axis and Y-axis and the plane 46. As described above, inspection tool 22, first cleaning tool 26, and second cleaning tool 30 are non-movably affixed in positions coplanar with the plane 46 of movement of the transceiver receptacle 14.

With continued reference to FIG. 6, in this example transceiver positioning mechanism 120 comprises an H-bot mechanism in which a single H-shaped circumferential timing belt 123 connects a third driven pulley 124 and fourth driven pulley 126. With reference also to FIG. 12, transceiver receptacle 14 is rotatably mounted to a receptacle arm 130 via bracket 132. Receptacle arm 130 is affixed to and extends from a receptacle arm base 136. Receptacle arm base 136 is affixed to belt 123 and is slidably coupled to a receptacle rail 140 for movement along the X-axis. Receptacle rail 140 is affixed to a receptacle positioning platform 142 that is slidably coupled to a left receptacle rail 144 and right receptacle rail 146, respectively, for movement along the Y-axis.

A first receptacle positioning motor 150 drives the third driven pulley 124, and a second receptacle positioning motor 152 drives the fourth driven pulley 126. In this example the timing belt 123 extends around a third idler pulley 154 spaced from the third driven pulley 124 and a fourth idler pulley 156 spaced from the fourth driven pulley 126. Timing belt 60 also extends around four receptacle idler pulleys 160 rotatably coupled to the receptacle positioning platform 142. In this manner and by selectively operating first receptacle positioning motor 150 and second receptacle positioning motor 152, the transceiver receptacle 14 can be moved along the X-axis and Y-axis for precise positioning of the transceiver for inspection and cleaning services.

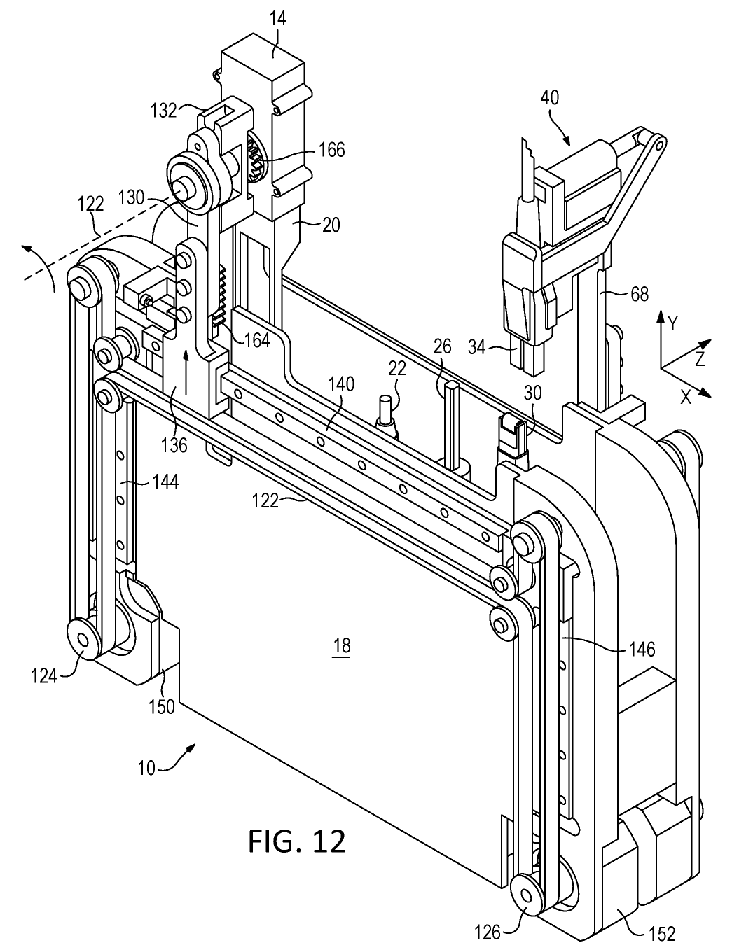

Additionally and as noted above, the transceiver positioning mechanism 120 is configured to rotate the transceiver receptacle 14 about a rotation axis 122 perpendicular to the plane 46 of movement from the loading orientation shown in FIG. 6 to the servicing orientation shown in FIG. 12. With reference to FIG. 11, the transceiver positioning mechanism 120 comprises a fixed pinion 164, and the transceiver receptacle is affixed to a spur gear 166 configured to engage the fixed pinion to rotate the transceiver receptacle about the rotation axis 122 when the transceiver receptacle 14 is translated in Y-axis direction.

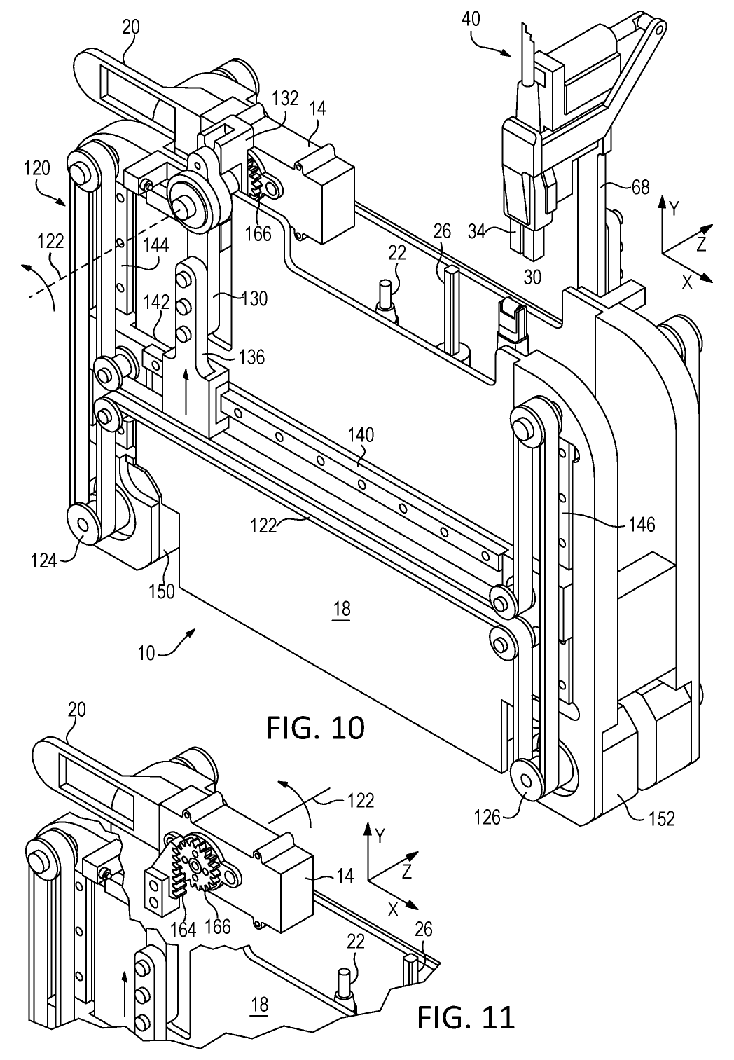

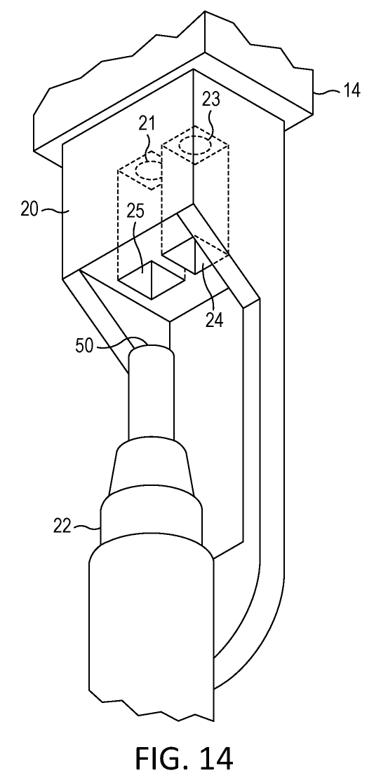

Turning to FIG. 8, from this loading orientation the transceiver receptacle 14 and seated transceiver 20 are translated in the positive Y-axis direction to engage the spur gear 166 with the fixed pinion 164, thereby rotating the transceiver receptacle 14 and seated transceiver 20 in a counter-clockwise direction (see FIG. 10) into the servicing orientation in which the two transceiver fiber receiving openings 24, 25 of the LC optical fiber transceiver 20 are facing in the negative Y-axis direction. From this position and with reference to FIG. 13, the transceiver positioning mechanism 120 translates the transceiver receptacle 14 and seated optical fiber transceiver 20 to the inspection tool 22 for inspection. Similar to the clamp positioning mechanism 44 described above, the transceiver positioning mechanism 120 restricts the movement of transceiver receptacle 14 and seated optical fiber transceiver 20 along plane 46 in the X-axis and Y-axis directions, with probe tip 50 of inspection tool 22, first cleaning tip 52 of the first cleaning tool 26, and second cleaning tip 54 of the second cleaning tool 30 each located coplanar with the plane 46 of movement of the transceiver receptacle 14 and seated optical fiber transceiver 20.

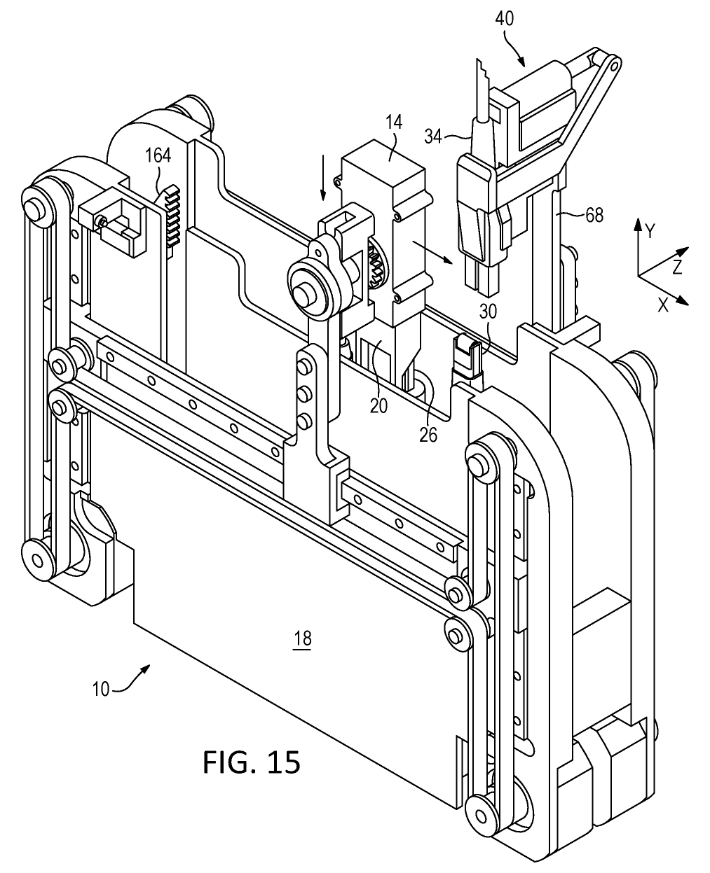

With reference to FIG. 13, in one potential advantage of the present disclosure, the transceiver positioning mechanism 120 is operated to move the transceiver receptacle 14 and seated optical fiber transceiver 20 along the X-Y axes and plane 46 to the inspection tool 22 to visually inspect a fiber end (core) within each of the transceiver fiber receiving openings 24. 25 of the optical fiber transceiver 20. In one potential advantage of the present disclosure, and with reference also to FIG. 14, transceiver positioning mechanism 120 is operated to position a first transceiver fiber receiving opening 25 near the probe tip 50 of the inspection tool 22 to inspect a first fiber end 21 inside the opening without contacting another surface. Advantageously, by inspecting the fiber end without contacting another surface, system 10 avoids introducing dust or other contaminants through contact with another surface near the fiber end.

In the present example, optical fiber transceiver 20 is an LC transceiver that includes two fiber receiving openings 24 and two corresponding optical fiber ends 21, 23. In this example the transceiver positioning mechanism 120 moves the optical fiber transceiver 20 along plane 46 in the X-axis direction, stopping at each fiber receiving opening to inspect the optical fiber end inside. In some examples, the transceiver positioning mechanism 120 adjusts the position of the LC transceiver to capture an accurate image of the fiber end.

As described above, a camera of inspection tool 22 captures one or more images of a fiber end and analyzes the image(s) to detect the core of the fiber end. Once a focused image of the core has been obtained, the image can be partitioned into multiple regions, and each region is processed to detect anomalies that correspond to dirt, dust, or other contaminants or defects. In some examples system 10 runs a classification algorithm to detect the number of anomalies in a specific region of the core, which number is compared to one or more thresholds to determine whether the region passes or fails the inspection. Where all regions pass inspection, cleaning the examined fiber end is not necessary. In other examples, other methods for utilizing an inspection tool to inspect a fiber end for anomalies can be utilized.

Advantageously, in examples where the optical fiber transceiver is an MPO transceiver that includes 8, 12, or more optical fibers and a corresponding number of optical fiber ends, and the camera of the inspection tool 22 has been properly positioned in the Y-axis direction to focus on one fiber end, the MPO transceiver can be quickly moved laterally in only the X-axis direction to sequentially focus on and inspect the each laterally-aligned fiber end of the connector. In this manner, system 10 enables rapid automated inspection of multiple fiber ends.

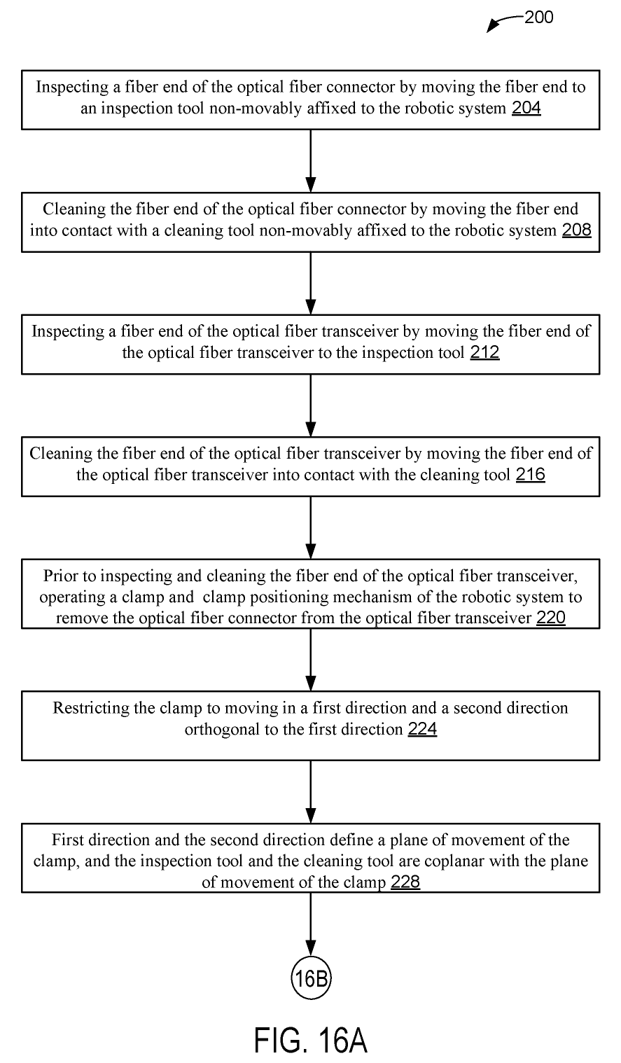

With reference now to FIG. 15, where inspection of the fiber ends 21, 23 determines that cleaning of one or more of the fiber ends is warranted, the transceiver positioning mechanism 120 is operated to move the optical fiber transceiver 20 to the first cleaning tool 26 (in the example an LC cleaning tool) to clean the fiber end(s) of the transceiver. In this example, transceiver positioning mechanism 120 is operated to move the optical fiber connector 34 along the X-axis to the first cleaning tool 26, and then move the connector along the Y-axis to cause the first cleaning tip 52 of the first cleaning tool to enter one of the transceiver fiber receiving openings 24, 25 and contact and clean the corresponding fiber end. Where the other fiber end is also to be cleaned, transceiver positioning mechanism 120 is operated to move the optical fiber connector 34 along the X-axis and Y-axis to cause the first cleaning tip 52 of the first cleaning tool 26 to enter the other transceiver fiber receiving opening and contact and clean the corresponding fiber end. In examples where the optical fiber transceiver is an MPO transceiver, the transceiver positioning mechanism 120 is operated to move the MPO transceiver to the second cleaning tool 30 (in the example an MPO cleaning tool) to clean the fiber ends of the MPO transceiver.

After inspecting and cleaning (if necessary) optical fiber transceiver 20, the transceiver positioning mechanism 120 is operated to translate the optical fiber transceiver in the negative X-axis direction until the spur gear 166 engages the fixed pinion 164, and translate the transceiver in the negative Y-axis direction to rotated and reposition the transceiver in the loading orientation of FIG. 8. The clamp positioning mechanism 44 may then be operated to reinsert the optical fiber connector 34 into the optical fiber transceiver 20.

In the present example, system 10 is contained within an enclosure that can take any suitable form.

While the present examples disclose inspecting and cleaning an optical fiber connector followed by inspecting and cleaning the optical fiber transceiver, in different examples the system 10 can inspect and clean an optical fiber transceiver followed by inspecting and cleaning an optical fiber connector. In some examples, a transceiver that does not contain an optical fiber connector can be inserted into transceiver receptacle 14, and system 10 can proceed to inspect and clean (if necessary) the transceiver. In some examples, system 10 utilizes a single cleaning tool having a configuration primarily designed for a selected configuration of optical fiber connector and corresponding transceiver.

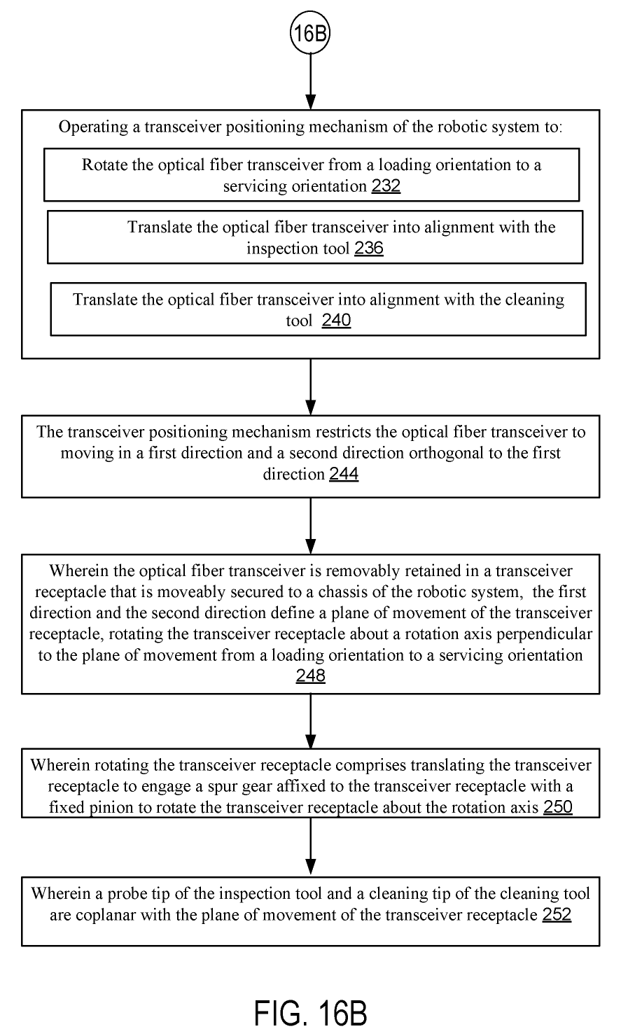

With reference now to FIGS. 16A-16B, a flow diagram is provided depicting an example method 200 for operating a robotic system to perform inspection and cleaning of an optical fiber connector and an optical fiber transceiver. The following description of method 200 is provided with reference to the configurations and components described herein and shown in FIGS. 1-15 and 17. In other examples, method 200 can be performed with other configurations of robotic systems using other suitable components.

The following description of method 200 is provided by way of example and is not meant to be limiting. Therefore, it is to be understood that method 200 may include additional and/or alternative steps relative to those illustrated in FIGS. 16A-16B. Further, it is to be understood that the steps of method 200 may be performed in any suitable order. Further still, it is to be understood that one or more steps may be omitted from method 200 without departing from the scope of this disclosure. It will also be appreciated that method 200 also may be performed in other contexts using other suitable components.

At 204 method 200 includes inspecting a fiber end of the optical fiber connector by moving the fiber end to an inspection tool non-movably affixed to the robotic system. At 208 method 200 includes cleaning the fiber end of the optical fiber connector by moving the fiber end into contact with a cleaning tool non-movably affixed to the robotic system. At 212 method 200 includes inspecting a fiber end of the optical fiber transceiver by moving the fiber end of the optical fiber transceiver to the inspection tool. At 216 method 200 includes cleaning the fiber end of the optical fiber transceiver by moving the fiber end of the optical fiber transceiver into contact with the cleaning tool.

At 220 method 200 includes prior to inspecting and cleaning the fiber end of the optical fiber transceiver, operating a clamp and clamp positioning mechanism of the robotic system to remove the optical fiber connector from the optical fiber transceiver. At 224 method 200 includes, restricting the clamp to moving in a first direction and a second direction orthogonal to the first direction. At 228 method 200 includes wherein the first direction and the second direction define a plane of movement of the clamp, and the inspection tool and the cleaning tool are coplanar with the plane of movement of the clamp.

With reference now to FIG. 16B, method 200 includes operating a transceiver positioning mechanism of the robotic system to, at 232, rotate the optical fiber transceiver from a loading orientation to a servicing orientation; at 236, translate the optical fiber transceiver into alignment with the inspection tool; and at 240 translate the optical fiber transceiver into alignment with the cleaning tool. At 244 method 200 includes restricting the optical fiber transceiver to moving in a first direction and a second direction orthogonal to the first direction. At 248 method 200 includes, wherein the optical fiber transceiver is removably retained in a transceiver receptacle that is moveably secured to a chassis of the robotic system, and the first direction and the second direction define a plane of movement of the transceiver receptacle, rotating the transceiver receptacle about a rotation axis perpendicular to the plane of movement from a loading orientation to a servicing orientation. At 250 method 200 includes, wherein rotating the transceiver receptacle comprises translating the transceiver receptacle to engage a spur gear affixed to the transceiver receptacle with a fixed pinion to rotate the transceiver receptacle about the rotation axis. At 252 method 200 includes wherein a probe tip of the inspection tool and a cleaning tip of the cleaning tool are coplanar with the plane of movement of the transceiver receptacle.

In some embodiments, one or more aspects of the methods and processes described herein may be tied to a computing system of one or more computing devices. In particular, such methods and processes may be implemented as a computer-application program or service, an application-programming interface (API), a library, and/or other computer-program product.

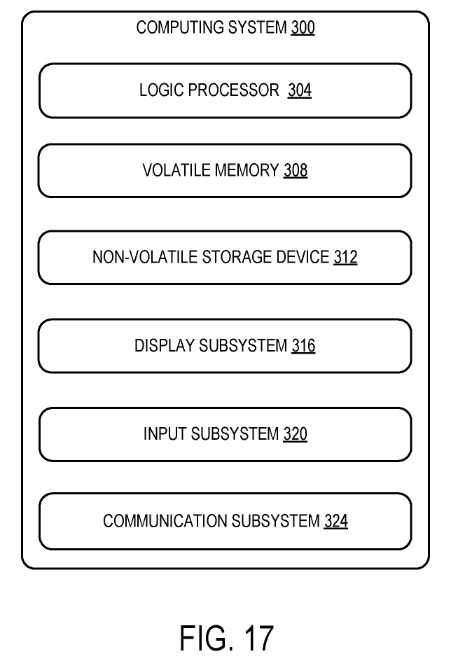

FIG. 17 schematically shows a simplified representation of a computing system 300 configured to provide any to all of the compute functionality described herein. Computing system 300 may take the form of one or more embedded computing devices, personal computers, network-accessible server computers, tablet computers, mobile computing devices, mobile communication devices (e.g., smart phone), virtual/augmented/mixed reality computing devices, wearable computing devices, Internet of Things (IoT) devices, and/or other computing devices. The processor 11 and memory 12 described above may comprise computing system 300 or one or more aspects of computing system 300.

Computing system 300 includes a logic processor 304, volatile memory 308, and a non-volatile storage device 312. Computing system 300 may optionally include a display subsystem 316, input subsystem 320, communication subsystem 324, and/or other components not shown in FIG. 17.

Logic processor 304 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor 304 may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 304 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 308 may include physical devices that include random access memory. Volatile memory 308 is typically utilized by logic processor 304 to temporarily store information during processing of software instructions. It will be appreciated that volatile memory 308 typically does not continue to store instructions when power is cut to the volatile memory 308.

Non-volatile storage device 312 includes one or more physical devices configured to hold instructions executable by the logic processors to implement the methods and processes described herein. When such methods and processes are implemented, the state of non-volatile storage device 312 may be transformed—e.g., to hold different data.

Non-volatile storage device 312 may include physical devices that are removable and/or built-in. Non-volatile storage device 312 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 312 may include nonvolatile, dynamic, static, read/write, read-only, sequential-access, location-addressable, file-addressable, and/or content-addressable devices. It will be appreciated that non-volatile storage device 312 is configured to hold instructions even when power is cut to the non-volatile storage device 312.

Aspects of logic processor 304, volatile memory 308, and non-volatile storage device 312 may be integrated together into one or more hardware-logic components. Such hardware-logic components may include field-programmable gate arrays (FPGAs), program- and application-specific integrated circuits (PASIC / ASICs), program- and application-specific standard products (PSSP / ASSPs), system-on-a-chip (SOC), microcontroller units (MCUs), and complex programmable logic devices (CPLDs), for example.

When included, display subsystem 316 may be used to present a visual representation of data held by non-volatile storage device 312. As the herein described methods and processes change the data held by the non-volatile storage device, and thus transform the state of the non-volatile storage device, the state of display subsystem 316 may likewise be transformed to visually represent changes in the underlying data. Display subsystem 316 may include one or more display devices utilizing virtually any type of technology. Such display devices may be combined with logic processor 304, volatile memory 308, and/or non-volatile storage device 312 in a shared enclosure, or such display devices may be peripheral display devices.

When included, input subsystem 320 may comprise or interface with one or more user-input devices such as a stylus, touchpad, keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 324 may be configured to communicatively couple various computing devices described herein with each other, and with other devices. Communication subsystem 324 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 300 to send and/or receive messages to and/or from other devices via a network such as the Internet.

The following paragraphs provide additional support for the claims of the subject application. One aspect provides a robotic system for automated inspection and cleaning of optical fiber components, the system comprising: a transceiver receptacle moveably secured to a chassis of the robotic system and configured to removably retain an optical fiber transceiver; a clamp moveably secured to the chassis and configured to remove an optical fiber connector from the optical fiber transceiver and reinsert the optical fiber connector into the optical fiber transceiver; an inspection tool non-movably affixed to the chassis and configured to inspect a fiber end of the optical fiber transceiver and a fiber end of the optical fiber connector; and a cleaning tool non-movably affixed to the chassis and configured to clean the fiber end of the optical fiber transceiver and the fiber end of the optical fiber connector. The robotic system may additionally or alternatively include a transceiver positioning mechanism configured to translate the transceiver receptacle in a first direction and a second direction orthogonal to the first direction. The robotic system may additionally or alternatively include wherein the first direction and the second direction define a plane of movement of the transceiver receptacle, and the transceiver positioning mechanism is configured to rotate the transceiver receptacle about a rotation axis perpendicular to the plane of movement from a loading orientation to a servicing orientation. The robotic system may additionally or alternatively include wherein the transceiver positioning mechanism comprises a fixed pinion, and the transceiver receptacle is affixed to a spur gear configured to engage the fixed pinion to rotate the transceiver receptacle about the rotation axis. The robotic system may additionally or alternatively include wherein a probe tip of the inspection tool and a cleaning tip of the cleaning tool are coplanar with the plane of movement of the transceiver receptacle. The robotic system may additionally or alternatively include wherein the transceiver positioning mechanism is configured to move the optical fiber transceiver to the inspection tool and to the cleaning tool. The robotic system may additionally or alternatively include a clamp positioning mechanism configured to translate the clamp in a first direction and a second direction orthogonal to the first direction. The robotic system may additionally or alternatively include wherein the first direction and the second direction define a plane of movement of the clamp, and the inspection tool and the cleaning tool are coplanar with the plane of movement of the clamp. The robotic system may additionally or alternatively include wherein the clamp positioning mechanism is configured to move the clamp to the inspection tool and to the cleaning tool.

Another aspect provides a method for operating a robotic system to perform inspection and cleaning of an optical fiber connector and an optical fiber transceiver, the method comprising: inspecting a fiber end of the optical fiber connector by moving the fiber end to an inspection tool non-movably affixed to the robotic system; cleaning the fiber end of the optical fiber connector by moving the fiber end into contact with a cleaning tool non-movably affixed to the robotic system; inspecting a fiber end of the optical fiber transceiver by moving the fiber end of the optical fiber transceiver to the inspection tool; and cleaning the fiber end of the optical fiber transceiver by moving the fiber end of the optical fiber transceiver into contact with the cleaning tool. The method may additionally or alternatively include operating a transceiver positioning mechanism of the robotic system to: rotate the optical fiber transceiver from a loading orientation to a servicing orientation; translate the optical fiber transceiver into alignment with the inspection tool; and translate the optical fiber transceiver into alignment with the cleaning tool. The method may additionally or alternatively include wherein the transceiver positioning mechanism restricts the optical fiber transceiver to moving in a first direction and a second direction orthogonal to the first direction. The method may additionally or alternatively include wherein the optical fiber transceiver is removably retained in a transceiver receptacle that is moveably secured to a chassis of the robotic system, the first direction and the second direction define a plane of movement of the transceiver receptacle, the method further comprising rotating the transceiver receptacle about a rotation axis perpendicular to the plane of movement from the loading orientation to the servicing orientation. The method may additionally or alternatively include wherein rotating the transceiver receptacle comprises translating the transceiver receptacle to engage a spur gear affixed to the transceiver receptacle with a fixed pinion to rotate the transceiver receptacle about the rotation axis. The method may additionally or alternatively include wherein a probe tip of the inspection tool and a cleaning tip of the cleaning tool are coplanar with the plane of movement of the transceiver receptacle. The method may additionally or alternatively include, prior to inspecting and cleaning the fiber end of the optical fiber transceiver, operating a clamp and a clamp positioning mechanism of the robotic system to remove the optical fiber connector from the optical fiber transceiver. The method may additionally or alternatively include wherein the clamp positioning mechanism restricts the clamp to moving in a first direction and a second direction orthogonal to the first direction. The method may additionally or alternatively include wherein the first direction and the second direction define a plane of movement of the clamp, and the inspection tool and the cleaning tool are coplanar with the plane of movement of the clamp.

Another aspect provides a robotic system for automated inspection and cleaning of optical fiber components, the system comprising: a chassis; a transceiver positioning mechanism affixed to the chassis and configured to translate a transceiver receptacle in a first direction and a second direction orthogonal to the first direction, the transceiver receptacle configured to removably retain an optical fiber transceiver; a clamp positioning mechanism affixed to the chassis and configured to translate a clamp in the first direction and the second direction orthogonal to the first direction, the clamp configured to remove an optical fiber connector from the optical fiber transceiver and reinsert the optical fiber connector into the optical fiber transceiver; an inspection tool non-movably affixed to the chassis and configured to inspect a fiber end of the optical fiber transceiver and a fiber end of the optical fiber connector; and a cleaning tool non-movably affixed to the chassis and configured to clean the fiber end of the optical fiber transceiver and the fiber end of the optical fiber connector. The robotic system may additionally or alternatively include wherein the transceiver positioning mechanism translates the transceiver receptacle in a plane of movement, and the transceiver positioning mechanism is configured to rotate the transceiver receptacle about a rotation axis perpendicular to the plane of movement from a loading orientation to a servicing orientation.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A robotic system for automated inspection and cleaning of optical fiber components, the system comprising:
a transceiver receptacle moveably secured to a chassis of the robotic system and configured to removably retain an optical fiber transceiver;
a clamp moveably secured to the chassis and configured to remove an optical fiber connector from the optical fiber transceiver and reinsert the optical fiber connector into the optical fiber transceiver;
an inspection tool non-movably affixed to the chassis and configured to inspect a fiber end of the optical fiber transceiver and a fiber end of the optical fiber connector; and
a cleaning tool non-movably affixed to the chassis and configured to clean the fiber end of the optical fiber transceiver and the fiber end of the optical fiber connector.

2. The robotic system of claim 1, further comprising a transceiver positioning mechanism configured to translate the transceiver receptacle in a first direction and a second direction orthogonal to the first direction.

3. The robotic system of claim 2, wherein the first direction and the second direction define a plane of movement of the transceiver receptacle, and the transceiver positioning mechanism is configured to rotate the transceiver receptacle about a rotation axis perpendicular to the plane of movement from a loading orientation to a servicing orientation.

4. The robotic system of claim 3, wherein the transceiver positioning mechanism comprises a fixed pinion, and the transceiver receptacle is affixed to a spur gear configured to engage the fixed pinion to rotate the transceiver receptacle about the rotation axis.

5. The robotic system of claim 3, wherein a probe tip of the inspection tool and a cleaning tip of the cleaning tool are coplanar with the plane of movement of the transceiver receptacle.

6. The robotic system of claim 3, wherein the transceiver positioning mechanism is configured to move the optical fiber transceiver to the inspection tool and to the cleaning tool.

7. The robotic system of claim 1, further comprising a clamp positioning mechanism configured to translate the clamp in a first direction and a second direction orthogonal to the first direction.

8. The robotic system of claim 7, wherein the first direction and the second direction define a plane of movement of the clamp, and the inspection tool and the cleaning tool are coplanar with the plane of movement of the clamp.

9. The robotic system of claim 7, wherein the clamp positioning mechanism is configured to move the clamp to the inspection tool and to the cleaning tool.

10. A method for operating a robotic system to perform inspection and cleaning of an optical fiber connector and an optical fiber transceiver, the method comprising:
inspecting a fiber end of the optical fiber connector by moving the fiber end to an inspection tool non-movably affixed to the robotic system;
cleaning the fiber end of the optical fiber connector by moving the fiber end into contact with a cleaning tool non-movably affixed to the robotic system;
inspecting a fiber end of the optical fiber transceiver by moving the fiber end of the optical fiber transceiver to the inspection tool; and
cleaning the fiber end of the optical fiber transceiver by moving the fiber end of the optical fiber transceiver into contact with the cleaning tool.

11. The method of claim 10, further comprising, operating a transceiver positioning mechanism of the robotic system to:
rotate the optical fiber transceiver from a loading orientation to a servicing orientation;
translate the optical fiber transceiver into alignment with the inspection tool; and
translate the optical fiber transceiver into alignment with the cleaning tool.

12. The method of claim 11, wherein the transceiver positioning mechanism restricts the optical fiber transceiver to moving in a first direction and a second direction orthogonal to the first direction.

13. The method of claim 12, wherein the optical fiber transceiver is removably retained in a transceiver receptacle that is moveably secured to a chassis of the robotic system, the first direction and the second direction define a plane of movement of the transceiver receptacle, the method further comprising rotating the transceiver receptacle about a rotation axis perpendicular to the plane of movement from the loading orientation to the servicing orientation.

14. The method of claim 13, wherein rotating the transceiver receptacle comprises translating the transceiver receptacle to engage a spur gear affixed to the transceiver receptacle with a fixed pinion to rotate the transceiver receptacle about the rotation axis.

15. The method of claim 13, wherein a probe tip of the inspection tool and a cleaning tip of the cleaning tool are coplanar with the plane of movement of the transceiver receptacle.

16. The method of claim 10, further comprising, prior to inspecting and cleaning the fiber end of the optical fiber transceiver, operating a clamp and a clamp positioning mechanism of the robotic system to remove the optical fiber connector from the optical fiber transceiver.

17. The method of claim 16, wherein the clamp positioning mechanism restricts the clamp to moving in a first direction and a second direction orthogonal to the first direction.

18. The method of claim 17, wherein the first direction and the second direction define a plane of movement of the clamp, and the inspection tool and the cleaning tool are coplanar with the plane of movement of the clamp.

19. A robotic system for automated inspection and cleaning of optical fiber components, the system comprising:
a chassis;
a transceiver positioning mechanism affixed to the chassis and configured to translate a transceiver receptacle in a first direction and a second direction orthogonal to the first direction, the transceiver receptacle configured to removably retain an optical fiber transceiver;
a clamp positioning mechanism affixed to the chassis and configured to translate a clamp in the first direction and the second direction orthogonal to the first direction, the clamp configured to remove an optical fiber connector from the optical fiber transceiver and reinsert the optical fiber connector into the optical fiber transceiver;
an inspection tool non-movably affixed to the chassis and configured to inspect a fiber end of the optical fiber transceiver and a fiber end of the optical fiber connector; and
a cleaning tool non-movably affixed to the chassis and configured to clean the fiber end of the optical fiber transceiver and the fiber end of the optical fiber connector.

20. The robotic system of claim 19, wherein the transceiver positioning mechanism translates the transceiver receptacle in a plane of movement, and the transceiver positioning mechanism is configured to rotate the transceiver receptacle about a rotation axis perpendicular to the plane of movement from a loading orientation to a servicing orientation.
